(19) United States
(12) Patent Application Publication
(10) Pub. No.: US 2009/0111043 A1
(43) Pub. Date: Apr. 30, 2009

(54) ENVIRONMENT-FRIENDLY TONER FOR ELECTROPHOTOGRAPHY AND METHOD OF PREPARING THE SAME

(75) Inventors: Hae-ree Joo, Anyang-si (KR); Jae-hyeuk Jeong, Suwon-si (KR); Kyung-yol Yon, Seongnam-si (KR); Deuck-woo Jang, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/193,940

(22) Filed: Aug. 19, 2008

(30) Foreign Application Priority Data
Oct. 29, 2007 (KR) 2007-109141

(51) Int. Cl. G03G 9/087; G03G 13/16; G03G 15/08

(52) U.S. Cl. 430/109.4; 430/137.14; 430/125.3; 399/252

(57) ABSTRACT

A toner for electrophotography includes a polyester-based resin, a colorant, a charge controlling agent, and a releasing agent, wherein the toner does not substantially comprise of an organic tin, and generates about 100 ppm or less of volatile organic compounds at a temperature of about 150 to about 200° C.

### CROSS-REFERENCE TO RELATED APPLICATIONS

This application claims priority from Korean Patent Application No. 10-2007-0109141, filed on Oct. 29, 2007, in the Korean Intellectual Property Office, the disclosure of which is incorporated herein in its entirety by reference.

### BACKGROUND OF THE INVENTION

1. Field of the Invention

The present general inventive concept relates to an environment-friendly toner for electrophotography, and more particularly, to an environment-friendly toner for electrophotography, which presents a reduced health risk for humans by reducing an amount of volatile organic materials generated in a fixing process of a printing process using the toner.

2. Description of the Related Art

In electrophotographic processes and electrostatic recording processes, an electrostatic latent image is formed by performing an exposure process on a uniformly charged photoreceptor, toner is attached to the electrostatic latent image to form a toner image, and the toner image is then transferred to a transfer member such as a transfer sheet. Then, the transferred toner image is fixed to the transfer member using various methods, such as a heating process, a pressing process, or a solvent vapor process. In general, in the fixing process, the transfer member having the toner image is passed between a fixing roll and a pressing roll and the toner is then fused to the transfer member by heating and pressing. The toner is fixed to the transfer member according to fixing conditions and a stable image is thereby formed.

It is well known that the printing process described above results in the generation of environmentally harmful materials such as volatile organic compounds (VOCs), which have adverse health effects. Users who are exposed to such a printing process can also recognize the generation of VOCs through their sense of smell.

As environmentally friendly products are introduced in response to various environmental regulations, there is a need to remove or decrease the generation of VOCs, since VOCs are damaging to the environment.

In general, toner for electrophotography consists of a significant amount of resin, a small amount of wax which acts as a releasing agent, a colorant, a charge controlling agent, and an external additive. The toner is primarily composed of organic materials, and is exposed to high temperature and pressure when it is passed through a fixing device during printing processes. Thus, excessive amounts of VOCs are generated in such printing processes. Therefore, to prevent the generation of VOCs, filtering devices can be additionally installed inside or outside of the printers to filter the VOCs.

However, as printing technologies require higher resolution and higher printing speeds, the toner is exposed to more stress, such as heat and pressure, and thus, more VOCs are generated. Therefore, the need for VOC filtering devices and large-sized VOC filtering devices increases, which, in turn, increases a cost associated with the printing processes.

Thus, there is a need to develop a toner for electrophotography that reduces the generation of VOCs without the requirement for additional filters or a VOC-removing device.

### SUMMARY OF THE INVENTION

Additional aspects and/or utilities of the present general inventive concept will be set forth in part in the description which follows and, in part, will be apparent from the description, or may be learned by practice of the general inventive concept.

The present invention provides an environment-friendly toner for electrophotography, which reduces the generation of volatile organic compounds (VOCs).

The present general inventive concept also provides a method of preparing the environment-friendly toner for electrophotography.

The present general inventive concept also provides an imaging method using the environment-friendly toner for electrophotography.

The present general inventive concept also provides an imaging apparatus using the environment-friendly toner for electrophotography.

The foregoing and/or other aspects and utilities of the present general inventive concept may be achieved by providing a toner for electrophotography including a polyester-based resin, a colorant, a charge controlling agent, and a releasing agent, wherein the toner does not substantially comprise of an organic tin, and generates about 100 ppm or less of volatile organic compounds at about 150 to about 200° C.

An amount of the organic tin may be about 0.01 or less % by weight based on a weight of the polyester-based resin.

The toner may generate about 1 to about 100 ppm of volatile organic compounds at about 150 to about 200° C.

The toner may generate about 50 ppm or less of an aromatic compound at about 150 to about 200° C.

The toner may further include a tetrahydrofurane-insoluble component and an amount of the tetrahydrofurane-insoluble may be about 20 or less % by weight based on a total weight of the toner.

An acid value of the toner may be about 1 to about 20 mg/KOH.

The foregoing and/or other aspects and utilities of the present general inventive concept may be achieved by providing a method of preparing a toner for electrophotography which includes pre-mixing a polyester-based binding resin, a colorant, a charge controlling agent, and a releasing agent, mixing the obtained pre-mixed mixture in an extruder and extruding the obtained mixture from the extruder, while simultaneously performing a vacuum exhaustion process in at least one of an inlet, a transfer tunnel, and an outlet of the extruder, and milling and classifying the extruded product to prepare the toner.

The mixing and extruding processes may each be performed two to three times.

The foregoing and/or other aspects and utilities of the present general inventive concept may be achieved by providing an imaging method which includes forming a visible image by attaching toner to a surface of a photoreceptor on which a latent image is formed, and transferring the visible image to a transfer member, wherein the toner includes a polyester-based resin, a colorant, a charge controlling agent, and a releasing agent, the toner does not substantially comprise of an organic tin, and generates about 100 ppm or less of volatile organic compounds at a temperature of about 150 to about 200° C.

An amount of the organic tin may be about 0.01 or less % by weight based on weight of the polyester-based resin.

The toner may generate about 1 to about 100 ppm of volatile organic compounds (VOCs) at a temperature of about 150 to about 200° C.

The toner may generate about 50 ppm or less of an aromatic compound at a temperature of about 150 to about 200° C.

The toner may include a tetrahydrofurane-insoluble component and an amount of the tetrahydrofurane-insoluble component may be about 20 or less % by weight based on a total weight of the toner.

An acid value of the toner may be about 1 to about 20 mg/KOH.

The foregoing and/or other aspects and utilities of the present general inventive concept may be achieved by providing an imaging apparatus including an organic photoreceptor, a charging unit which charges the organic photoreceptor, an image forming unit which forms a latent image on a surface of the organic photoreceptor, a receiving unit which receives toner, a supplying unit which supplies the toner to develop the latent image at the surface of the organic photoreceptor so as to develop a toner image, and a transferring unit which transfers the toner image from the surface of the photoreceptor to a transfer member, wherein the includes a polyester-based resin, a colorant, a charge controlling agent, and a releasing agent, and the toner does not substantially comprise of an organic tin, and generates about 100 ppm or less of volatile organic compounds at about 150 to about 200° C.

An amount of the organic tin may be about 0.01 or less % by weight based on weight of the polyester-based resin.

The toner may generate about 1 to about 100 ppm of volatile organic compounds (VOCs) at a temperature of about 150 to about 200° C.

The toner may generate about 50 ppm or less of an aromatic compound at a temperature of about 150 to about 200° C.

The toner may include a tetrahydrofurane-insoluble component and an amount of the tetrahydrofurane-insoluble component may be about 20 or less % by weight based on a total weight of the toner.

An acid value of the toner may be about 1 to about 20 mg/KOH.

The foregoing and/or other aspects and utilities of the present general inventive concept may be achieved by providing a toner for electrophotography which includes a binding resin, a charge controlling agent, and a releasing agent, wherein the toner does not substantially comprise of an organic tin and generates about 100 ppm or less of volatile organic compounds (VOCs) at a temperature of about 150 to about 200° C.

The foregoing and/or other aspects and utilities of the present general inventive concept may be achieved by providing a method of manufacturing a toner for electrophotography which includes mixing a binding resin, a charge controlling agent, and a releasing agent, wherein the toner does not substantially comprise of an organic tin and generates about 100 ppm or less of volatile organic compounds (VOCs) at a temperature of about 150 to about 200° C.

### BRIEF DESCRIPTION OF THE DRAWINGS

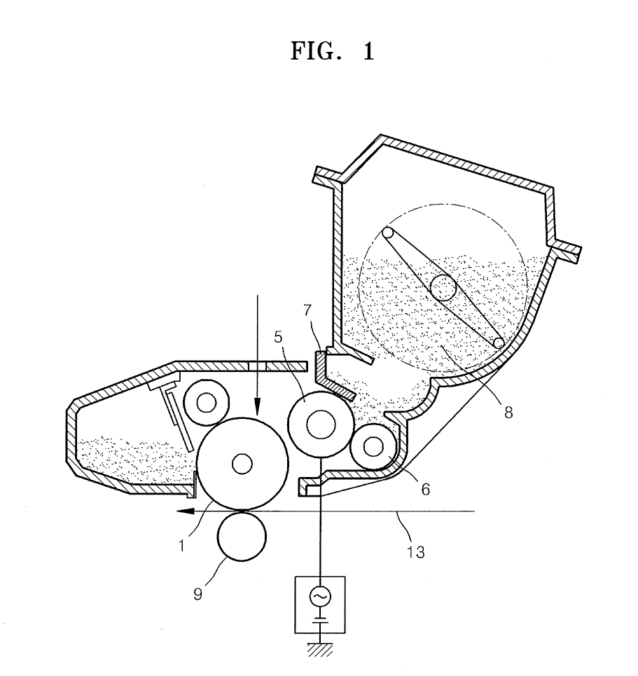

The above and/or other features and utilities of the present general inventive concept will become more apparent by describing in detail exemplary embodiments thereof with reference to FIG. 1 which illustrates an imaging apparatus using toner prepared according to an exemplary embodiment of the present general inventive concept.

### DETAILED DESCRIPTION OF THE PREFERRED EMBODIMENTS

The present general inventive concept will now be described more fully with reference to FIG. 1, in which exemplary embodiments of the present general inventive concept are illustrated.

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

An environment-friendly toner for electrophotography according to the present general inventive concept can be obtained by modifying conventional toner which causes volatile organic compounds (VOCs) to be generated in a printing process. Specifically, the environment-friendly toner for electrophotography according to the present general inventive concept does not contain an organic tin, which reduces the generation of VOCs to a small amount but has been determined to be an environmentally harmful material. Therefore, the environment-friendly toner for electrophotography according to the present general inventive concept is suitable for high-speed printing processes used for obtaining high resolution images.

The environment-friendly toner for electrophotography according to the present general inventive concept includes a polyester-based binding resin, a colorant, a charge controlling agent, and a releasing agent, but does not include an organic tin. When the environment-friendly toner for electrophotography according to the present general inventive concept is used, 100 ppm of VOCs at a temperature of about 150 to about 200° C. is generated, a measurement which is performed according to the Blue Angel criteria. However, the present general inventive concept is not limited thereto. That is, the amount of VOCs generated by the environment-friendly toner may vary according to other temperature ranges.

In general, excessive amounts of VOCs are generated in a fixing process of toner for electrophotography, specifically, in fixing conditions including a temperature of about 150 to about 200° C. Therefore, to prevent the formation or generation of VOCs, there is a need to decrease the amount of VOCs within the toner itself.

A polyester-based resin can act as a binder resin that is suitable for a color development process due to its high fixing properties and high degree of transparency. In a process of preparing the polyester-based resin, a high reaction efficiency is required to reduce the amount of a residual monomer in order to maintain the amount of VOCs generated at a low level. Therefore, to obtain a high reaction efficiency, the use of an organic tin as a catalyst is required. However, the organic tin is a type of an environmental hormone which disrupts the endocrine functions of humans. Therefore, a polyester-based resin prepared using the organic tin as a catalyst contains an excessive amount of the organic tin and therefore has adverse health effects for humans.

However, the organic tin which has adverse health effects can be replaced with an inorganic tin as a catalyst. The inorganic tin, however, provides lower reaction efficiency than the organic tin and the obtainable yield is low. As a result, the amount of unreacted residual monomer is increased and thus, toner prepared using this polyester-based resin would contain a large amount of VOCs. Therefore, a larger amount of VOCs are formed in a fixing process which is performed at a high temperature.

The present general inventive concept uses a polyester-based resin which is prepared without an organic tin as a catalyst and causes a reduction in the amount of VOCs generated in a process of preparing a toner. Therefore, the toner contains a small amount of VOCs therein and thus, in a high-temperature fixing process, the amount of VOCs generated can be maintained to be about 100 ppm or less.

Such effects can be obtained by vacuum-exhausting VOCs contained within the polyester-based binding resin through at least one of an inlet, a transfer tunnel, and an outlet of an extrusion device when components of the toner primarily consisting of a polyester-based binding resin that does not substantially contain an organic tin are stirred and extruded. In addition, VOCs can be more efficiently removed in such a manner that when a toner extrusion sample ejected from the outlet contains a higher amount of VOCs than in a reference sample, the toner extrusion sample can be stirred and extruded two to five times more until the amount of VOCs in the sample is reduced to a desired level. That is, in the preparation process for the toner, VOCs remaining in a source material of the toner can be exhausted to a vacuum atmosphere and the final product that is the toner would contain only a small amount of VOCs.

The environment-friendly toner for electrophotography according to the present general inventive concept includes a polyester-based binding resin, a colorant, a charge controlling agent, and a releasing agent, the polyester-based binding resin, and does not substantially contain an organic tin. In the environment-friendly toner for electrophotography according to the present general inventive concept, the amount of an organic tin may be about 0.01 or less % by weight, and more specifically in the range from about 0.00001 to 0.01% by weight, based on a weight of the polyester-based resin. However, the present general inventive concept is not limited thereto. Therefore, adverse health effects of the toner on humans, for example, can be substantially reduced.

Also, the environment-friendly toner for electrophotography according to the present general inventive concept does not substantially contain an organic tin, and can maintain the amount of VOCs to about 100 ppm or less at a temperature of about 150 to about 200° C., and more specifically to about 0.1 to about 100 ppm, according to the Blue Angel criteria. Specifically, the VOCs may contain an aromatic compound in an amount of about 50 ppm or less. In an exemplary embodiment, phenol, 2-(2-prophyenyl)benzene, or 5-chloro-2-methylbenzoxazole may exist in an amount of about 10 ppm or less, respectively. In alternative exemplary embodiments, a tetrahydrofuran-insoluble component of the toner may exist in an amount of about 20 or less % by weight, and more specifically of about 1 to about 15% by weight based on the total weight of the toner. Therefore, even when the toner is exposed to a high temperature of about 150 to about 200° C. in a fixing process of a printing process, the amount of VOCs generated can be reduced. That is, even when the VOCs are exposed to air, a user is less likely to inhale the VOCs. In addition, when a packaged toner is allowed to sit at a high temperature, the toner would be less likely to be contaminated by VOCs, since the amount of VOCs generated from the toner is low.

The environment-friendly toner for electrophotography according to the present general inventive concept is a polymerized or pulverised toner, and a colorant, a charge controlling agent (CCA), a releasing agent (wax) may be uniformly added to the inside of the toner in order to improve color purity, charging properties, and fixing properties. In exemplary embodiments, various types of external additives may be added to the toner in order to obtain fluidity, charge stability, and cleaning properties, when required.

Among the toner components stated above, the polyester-based resin does not substantially contain an organic tin. In an exemplary embodiment, the polyester-based resin may be a commercially available product having about 0.1 or less % by weight of an organic tin, such as HIMER SMH (produced by Sanyo Inc.), HIMER SHL (produced by Sanyo Inc.), or FC series (produced by MRC Inc.). However, the present general inventive concept is not limited thereto.

The colorant of the toner for electrophotography according to the present general inventive concept may be any dye or pigment that is well known in the art. In an exemplary embodiment, when the colorant is a black and white toner, the colorant may be carbon black or aniline black. However, the present general inventive concept is not limited thereto. The toner for electrophotography according to the present general inventive concept is suitable as a color toner, and, when the toner is a color toner, the toner includes carbon back as a black toner, and yellow, magenta, and cyan colorants as color colorants. However, the present general inventive concept is not limited thereto.

In exemplary embodiments, the yellow colorant may be a condensed nitrogen compound, an isoindolinone compound, an anthraquine compound, an azo metal complex, or an allyl imide compound. In an exemplary embodiment, the yellow colorant may be C.I. pigment yellow 12, 13, 14, 17, 62, 74, 83, 93, 94, 95, 109, 110, 111, 128, 129, 147, 168, or 180. However, the present general inventive concept is not limited thereto.

In exemplary embodiments, the magenta colorant may be a condensed nitrogen compound, anthraquine, a quinacridone compound, a base dye late compound, a naphthol compound, a benzo imidazole compound, a thioindigo compound, or a perylene compound. In an exemplary embodiment, the magenta colorant may be C.I. pigment red 2, 3, 5, 6, 7, 23, 48:2, 48:3, 48:4, 57:1, 81:1, 122, 144, 146, 166, 169, 177, 184, 185, 202, 206, 220, 221, or 254. However, the present general inventive concept is not limited thereto.

In exemplary embodiments, the cyan colorant may be a copper phthalocyanine compound, a derivative thereof, an anthraquine compound, or a base dye late compound. In an exemplary embodiment, the cyan colorant may be C.I. pigment blue 1, 7, 15, 15:1, 15:2, 15:3, 15:4, 60, 62, or 66. However, the present general inventive concept is not limited thereto.

In exemplary embodiments, the colorants stated above may be used alone, or in a mixture of at least two kinds thereof. In further exemplary embodiments, the colorant is determined according to color tone, chromaticity, luminosity, weather resistance, and dispersibility in toner.

In exemplary embodiments, the amount of the colorant may be in the range of about 0.1 to about 20 parts by weight based on 100 parts by weight of the binding resin. The amount of the colorant may be determined such that the toner is sufficiently colorized. However, when the amount of the colorant is less than about 0.1 parts by weight based on 100 parts by weight of the binding resin, sufficient coloring effects cannot be obtained. On the other hand, when the amount of the colorant is greater than about 20 parts by weight based on 100 parts by weight of the binding resin, the manufacturing costs of the toner may be significantly increased and sufficient friction charging cannot be obtained.

The toner for electrophotography according to the present general inventive concept is stably supported on a development roller by an electrostatic force, and the electrostatic force of the toner is generated by a charging blade. Therefore, a high charging speed is required. Thus, in exemplary embodiments, a charge controlling agent may be added to the toner in order to obtain charge stability of the toner for electrophotography. In exemplary embodiments, such a charge controlling agent may be selected from a group consisting of a Cr-containing azo-based dye; Cr, Fe, Zn, a metal-containing salicylic acid, such as Cr-containing salicylic acid, Fe-containing salicylic acid, or a Zn-containing salicylic acid; a boron complex of bis diphenylglycolic acid, and a silicate. However, the present general inventive concept is not limited thereto.

In exemplary embodiments, the amount of the charge controlling agent may be in the range from about 0.1 to about 20 parts by weight based on 100 parts by weight of the polyester-based binding resin. However, when the amount of the charge controlling agent is less than about 0.1 parts by weight based on 100 parts by weight of the polyester-based binding resin, a sufficient charging stability cannot be obtained. On the other hand, when the amount of the charge controlling agent is greater than about 20 parts by weight based on 100 parts by weight of the polyester-based binding resin, the manufacturing costs of the toner may be significantly increased.

Meanwhile, a need has been identified to develop a toner which has excellent fixing properties at low temperatures in order to decrease an amount of energy used and a pre-operating period of time before an initial use. Such a toner requires a releasing agent which has excellent fixing properties. In an exemplary embodiment, the releasing agent is a wax. In this regard, the type of wax can be determined according to an application of the toner composition. In exemplary embodiments, the wax may be, but is not limited to, a polyethylene-based wax, a polypropylene-based wax, a silicon wax, a paraffin-based wax, an ester-based wax, a carnauba wax, and a metallocene wax. In exemplary embodiments, the melting point of the wax may be in the range of about 50 to about 150° C. The particles of the wax may be physically close to the particles of the toner, but are not covalently bonded with the particles of the toner. However, the present general inventive concept is not limited thereto.

In exemplary embodiments, the amount of the wax may be in the range of about 0.1 to about 20 parts by weight based on 100 parts by weight of the polyester-based resin. However, when the amount of the wax is less than about 0.1 parts by weight based on 100 parts by weight of the polyester-based resin, fixing properties of the toner at a low temperature may be decreased. On the other hand, when the amount of the wax is greater than about 20 parts by weight based on 100 parts by weight of the polyester-based resin, the manufacturing costs of the toner may be increased.

A method of preparing the toner for electrophotography according to the present general inventive concept will now be described in detail. First, the polyester-based binding resin, the charge controlling agent, the releasing agent, and the colorant are homogeneously pre-mixed using a mixer, and then loaded into an extruder. Then, mixing and extruding processes are performed. In this regard, the mixture is vacuum-exhausted through at least one of an inlet, a transfer tunnel, and an outlet of the extruder in order to remove the VOCs. Then, the extruded mixture is milled and a milling classifier is used to obtain an untreated toner that is toner before an external additive is added thereto. Next, various types of external additives may be added to the untreated toner in order to provide particles of the toner with fluidity, charging stability, and cleaning properties.

When the amount of VOCs in a toner extrusion sample, which is ejected from the outlet, is greater than a reference level, the mixing and the extruding processes can be repeated until the amount of VOCs in the toner extrusion sample is reduced to a desired level. Therefore, the VOCs contained within the toner can be efficiently removed during the mixing and extruding processes. In exemplary embodiments, the mixing and extruding processes may be performed two or more times, and more specifically two or three more times.

In exemplary embodiments, the external additives which may be added to the untreated toner may be silicas (SiO₂), titanias (TiO₂), aluminas (Al₂O₃), polymer beads, or combinations thereof. However, the present general inventive concept is not limited thereto.

The toner according to the present general inventive concept may include a THF-insoluble component in an amount of about 50 or less % by weight, and more specifically in the range of about 0.1 to about 15% by weight based on the total amount of the toner in order to obtain sufficient offset-resistance and fixing properties. However, the present general inventive concept is not limited thereto. In an exemplary embodiment, an acidic value of the toner may be in the range of about 1 to about 20 mg/kOH, and more specifically in the range of about 1 to about 15 mg/kOH.

An imaging method according to an exemplary embodiment includes forming a visible image by attaching a toner to the surface of a photoreceptor having an electrostatic image and transferring the formed visible image onto a transfer member. The toner used in the imaging method according to the current exemplary embodiment contains a polyester-based binding resin, a colorant, a charge controlling agent, and a releasing agent, but does not substantially contain an organic tin. In a fixing process of the toner, about 100 ppm or less of VOCs are generated at a temperature of about 150 to about 200° C.

In general, an electrophotographic imaging method includes a charging process, an exposing process, a developing process, a transferring process, a fixing process, a cleaning process, and a charge-removing process, in order to form an image on a receptor.

In the charging process, a negative charge or a positive charge is applied to a photoreceptor by corona or a charging roller. In the exposing process, the charged surface of the photoreceptor is selectively discharged to form a latent image using an optical system such as a laser scanner or a diode arrangement. The latent image is formed in an imagewise manner such that the latent image corresponds to a desired image formed on a final image receptor. The optical system uses electromagnetic radiation, also referred to as “light”, which may be infrared light irradiation, visible light irradiation, or ultra-violet light irradiation. However, the present general inventive concept is not limited thereto.

In the developing process, particles of the toner having a sufficient polarity contact the latent image formed on the photoreceptor, and a developer having the same potential polarity as that of the toner, conventionally, an electrically-biased developer is used. In the developing process, appropriately-charged particles of the toner contact the latent image formed on the photoreceptor, and conventionally, an electrically-biased toner is used. The toner particles move toward the photoreceptor and are selectively attached to the latent image of the photoreceptor by an electrostatic force to thereby form a toner image on the photoreceptor.

In the transferring process, the toner image is transferred from the photoreceptor to a final image receptor. In some cases, an intermediate transferring element may be used to transfer the toner image from the photoreceptor to the final image receptor.

In the fixing process, the toner image on the final image receptor is heated so that particles of the toner are softened or dissolved and are fixed to the final image receptor. Alternatively, the toner image may be fixed to the final image receptor by heating or by compression at a high pressure without heating.

In the cleaning process, residual toner remaining on the photoreceptor is removed. Finally, in the charge-removing process, the charge of the photoreceptor is exposed to a specific wavelength band of light and is thereby uniformly reduced to a low value. Therefore, the residue of the latent image may be removed and the photoreceptor is available for a further imaging cycle.

An imaging apparatus according to an exemplary embodiment of the present general inventive concept includes an organic photoreceptor, a charging unit which charges the organic photoreceptor, a unit which forms a latent image on a surface of the organic photoreceptor, a unit which receives a toner, a unit which supplies the toner to develop the latent image on the surface of the organic photoreceptor so as to develop a toner image, and a unit which transfers the toner image from the surface of the photoreceptor to a transfer member. The toner used in the imaging apparatus according to the current exemplary embodiment contains a polyester-based binding resin, a colorant, a charge controlling agent, and a releasing agent, but does not substantially contain an organic tin, and in a fixing process of the toner, about 100 ppm or less of VOCs is generated at a temperature of about 150 to about 200° C.

FIG. 1 is a sectional view of a non-contact development type of imaging apparatus using a toner which is prepared using the method according to the present general inventive concept. An exemplary embodiment of an operational principle of the imaging apparatus will now be described in detail.

Referring to FIG. 1, a nonmagnetic one-component toner 8 consists of a carbonaceous material such as a polyurethane foam or a sponge. However, the present general inventive concept is not limited thereto. The nonmagnetic one-component toner 8 is supplied to a development roller 5 by a supply roller 6. The nonmagnetic one-component toner 8 which is supplied to the development roller 5 reaches a contact portion between a toner regulating blade 7 and the development roller 5, as the development roller 5 rotates.

In exemplary embodiments, the toner regulating blade 7 may be formed of a carbonaceous material of metal or rubber. However, the present general inventive concept is not limited thereto. When the nonmagnetic one-component toner 8 passes through the contact portion between the toner regulating blade 7 and the development roller 5, the nonmagnetic one-component toner 8 is regulated to be a thin layer and is sufficiently charged. The obtained thin layer of the nonmagnetic one-component toner 8 is transferred to a development area of a latent image formed on a photoreceptor 1 by the development roller 5. The nonmagnetic one-component toner 8 is then developed in the development area.

The development roller 5 and the photoreceptor 1 substantially face each other with a predetermined distant therebetween. In an exemplary embodiment, the development roller 5 rotates in a counter-clockwise direction, and the photoreceptor 1 rotates in a clockwise direction. The nonmagnetic one-component toner 8 in the development area is developed according to the latent image on the photoreceptor 1 by an electric power generated due to a potential difference between DC-overlapped AC voltage which is applied to the development roller 5 and a charge of the latent image of the photoreceptor 1.

The nonmagnetic one-component toner 8 developed on the photoreceptor 1 is transferred to a transfer member 9 as the photoreceptor 1 rotates. The nonmagnetic one-component toner 8 developed on the photoreceptor 1 is then transferred to a sheet of paper 13 by corona discharge or a roller to which a high voltage, which is opposite in polarity to that of the nonmagnetic one-component toner 8, is applied as the paper 13 passes through the nonmagnetic one-component toner 8 developed on the photoreceptor 1, and thus an image is formed.

The image transferred onto the paper 13 is fused to the paper 13 when it passes through a high-temperature and a high-pressure fixing device (not illustrated). In the meantime, the residual undeveloped toner on the development roller 5 is collected by the supply roller 6 which contacts the development roller 5. The processes described above are repeatedly performed and therefore a detailed description thereof will be omitted.

The present general inventive concept will be described in further detail with reference to the following examples. These examples are for illustrative purposes only and are not intended to limit the scope of the present general inventive concept.

### EXAMPLE 1

The following materials were used to prepare a non-magnetic one-component toner:

| | |
|---|---|
| Polyester resin containing 0.01 or less % by weight of | 90% by weight |
| an organic tin [HIMER SMH, Sanyo] | |
| Colorant: | 5% by weight |
| [Black, Mogul-L] | |
| Charge controlling agent: | 2% by weight |
| [LR-147, Carlit] | |
| Releasing agent (ester wax) | 3% by weight |
| [WE series, NOF]. | |

The components described above were homogeneously pre-mixed using a Henschel-type mixer, and then added to a double screw extruder including an inlet, a transfer tunnel, a mixing area and an outlet. The temperature in the transfer tunnel was in the range of 40 to 80° C., and the temperature in the mixing area was in the range of 100 to 130° C. The mixture was then extruded through the outlet. In this regard, the temperature of the extruded mixture was in the range of 100 to 140° C. The extruded mixture was cooled at room temperature and solidified. At this time, the inlet, transfer tunnel, and outlet of the double screw extruder were exposed to a vacuum to remove organic compounds evaporated in the process. Then, the extruded mixture was milled, and a milling classifier was used to obtain an untreated toner having an average particle size of about 8 μm.

Then, the untreated toner was subjected to a surface treatment using 2 parts by weight of large silica particles having an average particle size of 30-40 μm, 2 parts by weight of small silica particles having an average particle size of 5-10 μm, 0.5 parts by weight of titanium dioxide, and 0.5 parts by weight of melamine-based polymer beads, based on 100 parts by weight of particles of the untreated toner, at a rotation speed of 3000 rpm for 5 minutes. In this manner, a desired environment-friendly toner for electrophotography was prepared.

### EXAMPLE 2

The following materials were used to prepare a non-magnetic one-component toner:

| | |
|---|---|
| Polyester resin containing 0.01 or less % by weight of | 63% by weight |
| an organic tin [HIMER SMH, Sanyo] | |
| Polyester resin containing 0.01 or less % by weight | 17% by weight |
| of an organic tin [HIMER SML, Sanyo] | |
| Colorant [Black, Mogul-L] | 5% by weight |
| Charge controlling agent [LR-147 Carlit] | 2% by weight |
| Releasing agent (ester wax) [WE series, NOF] | 2% by weight |
| Releasing agent (ethylene-based wax) | 1% by weight. |
| [C-80, SEHHWA] | |

These components described above were homogeneously pre-mixed using a Henschel-type mixer, and then loaded into a double screw extruder including an inlet, a transfer tunnel, a mixing area and an outlet. The temperature in the transfer tunnel was in the range of 40 to 80° C. and the temperature in the mixing area was in the range of 100 to 130° C. The mixture was then extruded through the outlet. In this regard, the temperature of the extruded mixture was in the range of 100 to 140° C. The extruded mixture was cooled at room temperature and solidified. At this time, the inlet, transfer tunnel, and outlet of the double screw extruder were exposed to a vacuum to remove organic compounds evaporated in the process. Then, the extruded mixture was milled and a milling classifier was used to obtain an untreated toner having an average particle size of about 8 μm.

Then, the untreated toner was subjected to a surface treatment using 2 parts by weight of large silica particles having an average particle size of 30-40 μm, 2 parts by weight of small silica particles having an average particle size of 5-7 μm, 0.5 parts by weight of titanium dioxide, and 0.5 parts by weight of melamine-based polymer beads, based on 100 parts by weight of particles of the untreated toner, at a rotation speed of 3000 rpm for 5 minutes. In this manner, a desired environment-friendly toner for electrophotography was prepared.

### EXAMPLE 3

The following materials were used to prepare a non-magnetic one-component toner:

| | |
|---|---|
| Polyester resin containing 0.01 or less % by weight of | 90% by weight |
| an organic tin [HIMER SMH, Sanyo] | |
| Colorant [Black, Mogul-L] | 5% by weight |
| Charge controlling agent [LR-147 Carlit] | 2% by weight |
| Releasing agent (ester wax) [WE series, NOF] | 3% by weight. |

The components described above were homogeneously pre-mixed using a Henschel-type mixer, and then loaded into a double screw extruder including an inlet, a transfer tunnel, a mixing area and an outlet. The temperature in the transfer tunnel was in the range of 40 to 80° C., and the temperature in the mixing area was in the range of 100 to 130° C. The mixture was then extruded through the outlet. In this regard, the temperature of the extruded mixture was in the range of 100 to 140° C. The extruded mixture was cooled at room temperature and solidified. At this time, the inlet, transfer tunnel, and outlet of the double screw extruder were exposed to a vacuum to remove organic compounds evaporated in the process. The extrusion mixture ejected from the outlet was loaded into the extruder and the extrusion process was repeated. The extrusion temperature was adjusted to the same or lower temperature than the first extrusion temperature, that is, a second extrusion temperature was in the range of 100 to 120° C. Then, the extruded mixture was milled and a milling classifier was used to obtain an untreated toner having an average particle size of about 8 μm.

Then, the untreated toner was subjected to a surface treatment using 2 parts by weight of large silica particles having an average particle size of 30-40 μm, 2 parts by weight of small silica particles having an average particle size of 5-10 μm, 0.5 parts by weight of titanium dioxide, 0.5 parts by weight of melamine-based polymer beads, based on 100 parts by weight of particles of the untreated toner, at a rotation speed of 3000 rpm for 5 minutes. In this manner, a desired environment-friendly toner for electrophotography was prepared.

### COMPARATIVE EXAMPLE 1

The following materials were used to prepare a non-magnetic one-component toner:

| | |
|---|---|
| Polyester resin containing 0.1 or more % by weight of | 90% by weight |
| an organic tin (Sunjin Co., ltd.) | |
| Colorant [Black, Mogul-L] | 5% by weight |
| Charge controlling agent [LR-147 Carlit] | 2% by weight |
| Releasing agent (ester wax) [WE series, NOF] | 3% by weight. |

The components described above were homogeneously pre-mixed using a Henschel-type mixer, and then loaded into a double screw extruder including an inlet, a transfer tunnel, a mixing area and an outlet. The temperature in the transfer tunnel was in the range of 40 to 80° C., and the temperature in the mixing area was in the range of 100 to 130° C. The mixture was then extruded through the outlet. In this regard, the temperature of the extruded mixture was in the range of 100 to 140° C. The extruded mixture was cooled at room temperature and solidified. Then, the obtained mixture was milled, and a milling classifier was used to obtain an untreated toner having an average particle size of about 8 μm.

Then, the untreated toner was subjected to a surface treatment using 2 parts by weight of large silica particles having an average particle size of 30-40 μm, 2 parts by weight of small silica particles having an average particle size of 5-10 μm, 0.5 parts by weight of titanium dioxide, 0.5 parts by weight of melamine-based polymer beads, based on 100 parts by weight of particles of the untreated toner, at a rotation speed of 3000 rpm for 5 minutes. In this manner, a desired environment-friendly toner for electrophotography was prepared.

### COMPARATIVE EXAMPLE 2

The following materials were used to prepare a non-magnetic one-component toner:

| | |
|---|---|
| Polyester resin containing 0.1 or more % by weight of | 90% by weight |
| an inorganic tin (Sunjin Co., Ltd.) | |
| Colorant [Black, Mogul-L] | 5% by weight |
| Charge controlling agent [LR-147 Carlit] | 2% by weight |
| Releasing agent (ester wax) [WE series, NOF] | 3% by weight. |

The components described above were homogeneously pre-mixed using a Henschel-type mixer, and then loaded into a double screw extruder including an inlet, a transfer tunnel, a mixing area and an outlet. The temperature in the transfer tunnel was in the range of 40 to 80° C., and the temperature in the mixing area was in the range of 100 to 130° C. The mixture was then extruded through the outlet. In this regard, the temperature of the extruded mixture was in the range of 100 to 140° C. The extruded mixture was cooled at room temperature and solidified. Then, the obtained mixture was milled, and a milling classifier was used to obtain an untreated toner having an average particle size of about 8 μm.

Then, the untreated toner was subjected to a surface treatment using 2 parts by weight of large silica particles having an average particle size of 30-40 μm, 2 parts by weight of small silica particles having an average particle size of 5-10 μm, 0.5 parts by weight of titanium dioxide, 0.5 parts by weight of melamine-based polymer beads, based on 100 parts by weight of particles of the untreated toner, at a rotation speed of 3000 rpm for 5 minutes. In this manner, a desired environment-friendly toner for electrophotography was prepared.

### COMPARATIVE EXAMPLE 3

The following materials were used to prepare a non-magnetic one component toner:

| | |
|---|---|
| Polyester resin containing 0.01 or less % by weight of | 90% by weight |
| an organic tin [HIMER SMH, Sanyo] | |
| Colorant [Black, Mogul-L] | 5% by weight |
| Charge controlling agent [LR-147 Carlit] | 2% by weight |
| Releasing agent (ester wax) [WE series, NOF] | 3% by weight. |

The components described above were homogeneously pre-mixed using a Henschel-type mixer, and then loaded into a double screw extruder including an inlet, a transfer tunnel, a mixing area and an outlet. The temperature in the transfer tunnel was in the range of 40 to 80° C., and the temperature in the mixing area was in the range of 100 to 130° C. The mixture was then extruded through the outlet. In this regard, the temperature of the extruded mixture was in the range of 100 to 140° C. The extruded mixture was cooled at room temperature and solidified. Then, the obtained mixture was milled and a milling classifier was used to obtain an untreated toner having an average particle size of about 8 μm.

Then, the untreated toner was subjected to a surface treatment using 2 parts by weight of large silica particles having an average particle size of 30-40 μm, 2 parts by weight of small silica particles having an average particle size of 5-10 μm, 0.5 parts by weight of titanium dioxide, 0.5 parts by weight of melamine-based polymer beads, based on 100 parts by weight of particles of the untreated toner, at a rotation speed of 3000 rpm for 5 minutes. In this manner, a desired environment-friendly toner for electrophotography was prepared.

### EXPERIMENTAL EXAMPLE 1

### Analysis of Volatile Organic Compound (VOC)

This analysis was performed according to the Blue Angel criteria.

<Analysis Equipment: TDS/CIS-GC/MS>

A sample to be analyzed was loaded into a TDS tube (CD=6 mm, ID=4 mm, length=178 mm (7″)) and thermally desorbed at high temperature. Then, the thermally desorbed component was concentrated in CIS and the concentrated product was loaded into a GC column to identify the amount of the generated volatile organic compounds.

<Measurement Conditions>

(1) Amount of Sample: about 10 mg of toner

(2) GC/MS column: HP-1 ms or HP-5 ms

(3) GC oven: 40° C. (4 min)→140° C. @ 5° C./min
140° C. (0 min)→240° C. @ 10° C./min
240° C. (0 min)→290° C. (5 min) @ 25° C./min

(4) TDS: 25° C.→200° C. (5 min) [60° C./min] (splitless)

(5) CIS: −50° C.→320° C. (12° C./min)

<Measurement Results>

1. Amounts of TVOC

The total volatile organic compound (TVOC) was measured according to the Blue Angel criteria. In GC results, a TVOC area was defined as an area where hexane(C6)-hexadecan (C16) was detected. VOCs having 90% or more of matching rate with reference data of VOCs are illustrated in Table 1. The amount of VOCs was a relative amount with respect to the amount of VOCs generated in Comparative Example 1, being set as 1.

TABLE 1

| Volatile organic | | | | Comparative | Comparative | Comparative |
|---|---|---|---|---|---|---|
| compound | Example 1 | Example 2 | Example 3 | Example 1 | Example 2 | Example 3 |
| phenol | N.D (not | N.D | N.D | 1 | 4.42 | 4.81 |
| | detected) | | | | | |
| 2-ethyl hexanonic | N.D | N.D | N.D | N.D | 33808 | 46270 |
| acid | | | | | (amount/weight) | (amount/weight) |
| 2-(2-prophenyl) | N.D | N.D | N.D | 1 | 2.51 | 2.96 |
| benzene | | | | | | |
| 2-phenoxyethanol | N.D | N.D | N.D | 1 | 1.18 | 0.93 |
| 1-phenoxy-2- | N.D | N.D | N.D | 1 | 0.62 | 0.62 |
| propanol | | | | | | |
| 5-chloro-2- | N.D | N.D | N.D | 1 | 1 | 2.26 |
| methylbenzoxanol | | | | | | |
| TVOC (ppm) | 75 | 62 | 34 | 220 | 350 | 150 |

Referring to Table 1, the toners prepared according to Examples 1 through 3 did not generate VOCs; on the other hand, the toners prepared according to Comparative Examples 1 through 3 caused various types of aromatic compounds, such as phenol which has adverse health effects on humans, 2-(2-prophyenyl)benzene, 2-phenoxyethanol, or benzophenone.

2. Image Assessment Results

A 25 ppm-standard LBP printer was operated using the toners prepared according to Examples 1 through 3, and Comparative Examples 1 through 3. The results are illustrated in Table 2 below.

<Identification of THF-Insoluble Component Measurement>

0.5 g of toner or resin, and 50 ml of THF were added in a vessel and sufficiently dissolved by stirring for three hours. Separately, a paper filter was placed on a glass filter, a celite was added thereto, and THF was poured onto the resultant paper filter while pressure was decreased in order to package the resultant structure. A toner solution was filtered using the obtained filter and the weight of the filtered THF-insoluble component was measured. Therefore, the ratio of the THF-insoluble component to the other components in the toner solution was able to be determined.

<Acid Value>

Acid value is the mass of potassium hydroxide (KOH) in milligrams that is required to neutralize one gram of toner. 0.1 g of toner was dissolved in a co-solvent of THF/EtOH, and then titrated using KOH. 1 g of toner was loaded into a 200 ml vessel and 120 ml of THF was added thereto and shaken for 10 about hours. The obtained toner solution was loaded into a 250 ml beaker, 30 ml of ethanol was added thereto, and then they were mixed together using a magnetic stirrer. The acid value of the obtained mixture was measured using 0.1N KOH solution in a burette.

<Migration Test>

First, an initial image was printed, and then, after a high temperature package test was performed, the same image was printed again. The two images were compared to each other with the naked eye to determine if any damage occurred on the images due to contamination of a toner. The results are illustrated in Table 2.

TABLE 2

| | | | | Comparative | Comparative | Comparative |
|---|---|---|---|---|---|---|
| | Example 1 | Example 2 | Example 3 | Example 1 | Example 2 | Example 3 |
| THF-insoluble | 0~5% | 5~12% | 0~5% | 10~20% | 10~20% | 0~5% |
| Component | | | | | | |
| (%) | | | | | | |
| Acid Value | 8 | 7 | 7 | 28 | 30 | 7 |
| (mg/KOH) | | | | | | |
| Migration Test | No damage | No damage | No damage | Damage | Damage | Small |
| | occurred | occurred | occurred | occurred | occurred | amount of |
| | | | | | | damage |
| | | | | | | occurred a |

Referring to Table 2, the toners for electrophotography prepared according to Examples 1 through 3 had smaller amounts of THF-insoluble component and lower acid values than those prepared according to Comparative Examples 1 through 3, and the images obtained using the toners prepared according to Examples 1 through 3 were not damaged due to contamination of the toner. However, the images obtained using the toners prepared according to Comparative Examples 1 through 3 were damaged due to contamination of the toner. An environment-friendly toner for electrophotography according to the present general inventive concept uses a very small amount of organic tin, and thus, the amount of VOCs generated in a printing process can be substantially reduced using the toner. Therefore, the toner is not harmful to the human body. Also, the toner itself contains only a small amount of VOCs and therefore can be used in high-speed printers for producing high resolution images. In addition, since the amount of VOCs in the toner is low, contamination of a toner due to VOCs occurring when a packaged toner is exposed to high temperature can be prevented. Furthermore, since the toner itself has a very small amount of VOCs, there is no need to use an additional filter or apparatus for removing VOCs generated in the printing process.

While the present general inventive concept has been particularly shown and described with reference to a few exemplary embodiments thereof, it will be understood by those of ordinary skill in the art that various changes in form and details may be made therein without departing from the spirit and scope of the present general inventive concept as defined by the following claims.

What is claimed is:

1. A toner for electrophotography, comprising:
a polyester-based resin;
a colorant;
a charge controlling agent; and
a releasing agent,
wherein the toner does not substantially of comprise an organic tin, and generates about 100 ppm or less of volatile organic compounds (VOCs) at a temperature of about 150 to about 200° C.

2. The toner of claim 1, wherein an amount of the organic tin is about 0.01 or less % by weight based on weight of the polyester-based resin.

3. The toner of claim 1, wherein the toner generates about 1 to about 100 ppm of volatile organic compounds (VOCs) at a temperature of about 150 to about 200° C.

4. The toner of claim 1, wherein the toner generates about 50 ppm or less of an aromatic compound at a temperature of about 150 to about 200° C.

5. The toner of claim 1, wherein an amount of a tetrahydrofurane-insoluble component of the toner is about 20 or less % by weight based on a total weight of the toner.

6. The toner of claim 1, wherein an acid value of the toner is about 1 to about 20 mg/KOH.

7. A method of preparing a toner for electrophotography, the method comprising:
pre-mixing a polyester-based binding resin, a colorant, a charge controlling agent, and a releasing agent;
mixing the obtained pre-mixed mixture in an extruder and extruding the obtained mixture from the extruder, while simultaneously performing a vacuum exhaustion process in at least one of an inlet, transfer tunnel, and outlet of the extruder; and
milling and classifying the extruded product to prepare the toner.

8. The method of claim 8, wherein the mixing and extruding processes are each performed two to three times.

9. An imaging method comprising:
forming a visible image by attaching toner to a surface of a photoreceptor on which a latent image is formed; and
transferring the visible image to a transfer member,
wherein the toner includes a polyester-based resin, a colorant, a charge controlling agent, and a releasing agent, the toner does not substantially comprise of an organic tin and generates about 100 ppm or less of volatile organic compounds (VOCs) at a temperature of about 150 to about 200° C.

10. The imaging method of claim 9, wherein an amount of the organic tin is about 0.01 or less % by weight based on weight of the polyester-based resin.

11. The imaging method of claim 9, wherein the toner generates about 1 to about 100 ppm of volatile organic compounds (VOCs) at a temperature of about 150 to about 200° C.

12. The imaging method of claim 9, wherein the toner generates about 50 ppm or less of an aromatic compound at a temperature of about 150 to about 200° C.

13. The imaging method of claim 9, wherein the toner includes a tetrahydrofurane-insoluble component and an amount of the tetrahydrofurane-insoluble component is about 20 or less % by weight based on a total weight of the toner.

14. The imaging method of claim 9, wherein an acid value of the toner is about 1 to about 20 mg/KOH.

15. An imaging apparatus comprising:
an organic photoreceptor;
a charging unit which charges the organic photoreceptor;
a forming unit which forms a latent image on a surface of the organic photoreceptor;
a receiving unit which receives toner;
a supplying unit which supplies the toner to develop the latent image on the surface of the organic photoreceptor so as to develop a toner image; and
a transferring unit which transfers the toner image from the surface of the photoreceptor to a transfer member,
wherein the toner includes a polyester-based resin, a colorant, a charge controlling agent, and a releasing agent, the toner does not substantially comprise of an organic tin, and generates about 100 ppm or less of volatile organic compounds (VOCs) at a temperature of about 150 to about 200° C.

16. The imaging method of claim 15, wherein an amount of the organic tin is about 0.01 or less % by weight based on weight of the polyester-based resin.

17. The imaging method of claim 15, wherein the toner generates about 1 to about 100 ppm of volatile organic compounds (VOCs) at a temperature of about 150 to about 200° C.

18. The imaging method of claim 15, wherein the toner generates about 50 ppm or less of an aromatic compound at a temperature of about 150 to about 200° C.

19. The imaging method of claim 15, wherein the toner includes a tetrahydrofurane-insoluble component and an amount of the tetrahydrofurane-insoluble component is about 20 or less % by weight based on a total weight of the toner.

20. The imaging method of claim 15, wherein an acid value of the toner is about 1 to about 20 mg/KOH.

21. A toner for electrophotography, comprising:
a binding resin;
a charge controlling agent; and
a releasing agent,
wherein the toner does not substantially comprise of an organic tin and generates about 100 ppm or less of volatile organic compounds (VOCs) at a temperature of about 150 to about 200° C.

22. A method of manufacturing a toner for electrophotography, comprising:
mixing a binding resin, a charge controlling agent, and a releasing agent,
wherein the toner does not substantially comprise of an organic tin and generates about 100 ppm or less of volatile organic compounds (VOCs) at a temperature of about 150 to about 200° C.
